(19) United States
(12) Patent Application Publication
(10) Pub. No.: US 2002/0197926 A1
(43) Pub. Date: Dec. 26, 2002

(54) Knit fabrics for use in industrially launderable garments and garments made therefrom

(76) Inventors: A. Steven Hall, Spartanburg, SC (US); Larry H. Stephens, Spartanburg, SC (US)

Correspondence Address: Sara M. Current, Legal Department, M-495, Milliken & Company, PO Box 1926, Spartanburg, SC, 29304, US

(21) Appl. No.: 10/213,175

(22) Filed: Aug. 6, 2002

Related U.S. Application Data
(63) Continuation of application No. 09/591,664, filed on Jun. 9, 2000.

(51) Int. Cl. D04B 7/00; B32B 27/12; D04B 9/00; D04B 21/00; D04B 11/00; D04B 1/00

(52) U.S. Cl. 442/304

(57) ABSTRACT

A fabric particularly useful in the manufacture of industrially launderable garments is described. The fabric has high strength, good color retention, moisture transport, soil release properties and pilling resistance and retains those properties through a number of industrial laundering processes. A method for making the fabrics and garments made from the fabrics are also described.

### FIELD OF THE INVENTION

The invention generally relates to fabrics for use in the manufacture of garments designed to withstand the rigors of repeated industrial launderings, and garments made from the fabrics. More specifically, the invention relates to garments having good stretch and comfort characteristics, and which have good color retention and pilling characteristics following repeated industrial launderings.

### BACKGROUND

It is well known that knit garments are often preferred over their woven counterparts, due to the enhanced comfort provided by the stretch characteristics inherent in many such knit products. For example, athletes' uniforms are commonly manufactured from knit fabrics as opposed to woven fabrics, due to the fact that these garments, when properly fitted to the wearer, do not tend to bind or otherwise limit the wearer's motions. Similarly, golfwear, tenniswear, and other types of garments designed to be worn during rigorous activity are typically made from knit fabrics.

Such knit fabrics are commonly made from cotton or blends of cotton with synthetic fibers such as polyester. This is due to the recognition of cotton as a fiber having good absorbency and wicking characteristics.

It has been found that the degree of comfort provided by a garment, particularly during rigorous activity, is related to the degree it can remove moisture (e.g. perspiration) from the wearer's skin. Therefore, cotton's hydrophilic nature enables it to quickly wick the moisture from a wearer's body. However, it is this hydrophilic nature which renders cotton reluctant to release the moisture once it is absorbed. This can result in the garment becoming moisture logged and uncomfortable after a length of time. Another advantage associated with cotton is the hand it provides. It has been found that consumers generally prefer the feel of cotton, which is soft and “natural” feeling, to that of many synthetic fibers.

Some disadvantages associated with all-cotton products are that cotton fibers are typically less durable than their synthetic counterparts, and they do not generally have good color retention. In other words, a typical 100% cotton apparel article will often have a “worn” look after only a few home launderings. Furthermore, the use of bleach in the laundering process, which is often necessary in order to recapture the initial garment color (e.g. in white garments), degrades the cotton fibers and reduces their lifespan. In addition, cotton dyeing processes generally result in a natural-colored core surrounded by a dyed sheath. Therefore, as the sheath is worn away through wear and laundering, the garment color is negatively affected.

For this reason, manufacturers often blend cotton with synthetic fibers such as polyester in order to increase the durability and color retention of the fabrics, while retaining a significant portion of the desirable cotton traits, such as hand and moisture absorption. In other words, it is typically believed that a significant percentage of cotton is required to obtain a garment that is sufficiently comfortable to the wearer. Therefore, knit shirts are commonly provided as polyester/cotton blends, typically in a 65/35 ratio.

While cotton and polyester/cotton knit garments, and in particular shirts, have developed wide acceptability in the consumer recreational markets, heretofore such knit products have not gained acceptability in the occupational apparel markets for a number of reasons. The primary reason is that occupational garments are typically rented, and processed through commercial laundries using industrial laundering processes. While a garment manufacturer may specify in the care instructions of a garment that the garment is to be processed using more delicate processes, the practical reality is that these garments are processed in the manner of other industrial and rental items, which means that they are processed using industrial laundering techniques. As will be readily appreciated by those of ordinary skill in the art, conventional industrial laundering processes utilize high wash temperatures at high pH levels. These processes are usually seen to be required to achieve adequate cleaning and sanitization of the items.

The disadvantage of laundering garments such as conventional knit shirts according to these processes is that garment degradation is rapidly realized. For one, conventional polyester/cotton and 100% cotton products tend to lose their initial color due to the harsh laundering conditions. In addition, the polyester/cotton products can tend to pill undesirably in response to the harsh processes. Furthermore, the strength of the fabrics is degraded relatively quickly. As a result, conventional knit garments, and in particular, conventional cotton and polyester/cotton shirts, have not been found to be suitable for the occupational apparel market.

Another problem associated with the conventional knit garments is that they can tend to stain. As will be appreciated by those of ordinary skill in the art, occupational garments may be exposed to a variety of potential stains depending on their particular end use, including but not limited to food, blood, ink, perspiration, dirt, oil and the like. Since rental uniforms are typically worn by a number of different individuals, the presence of a stain on a just-laundered garment can give the appearance of uncleanliness to the garment, as well as an undesirable impression to those viewing the wearer in the stained garment.

Attempts to produce knit shirts capable of withstanding a number of industrial launderings were described in U.S. Pat. Nos. 5,467,512, 5,477,595, 5,515,699, 5,515,700, all to Weingarten et al., the disclosures of which are incorporated herein by reference. In particular, the patents describe the production of knit rental shirts by air jet spinning an intimate blend of about 50/50 polyester/cotton having wrapper fibers holding the yarn bundle together, vat dyeing the cotton component of the yarn and disperse dyeing the polyester component, then knitting the dyed yarn to produce a fabric with tightly formed stitches. The patent describes that the yarn is also scoured and finished prior to knitting. While these products represent an improvement over some of the conventionally available products, they still are less than optimal in their performance. For one, the manufacturing cycle can be relatively long due to the need to determine the desired color of the end garment in advance, then dye the yarn the appropriate color using the two different types of dyes as described above. In addition, it is believed that these fabrics would have only limited wicking capabilities due to the fiber blend utilized. Furthermore, the fabrics and garments of those patents would have less strength than would be optimal, particularly for the rental garment end use market.

### SUMMARY

The present invention provides a fabric and garment which provide good comfort, strength, and durability, and which retain their performance characteristics and color shade following repeated launderings under industrial laundering conditions. In addition, the fabrics and garments of the present invention provide a hand similar yet superior to that of similar weight polyester/cotton blended fabrics, while being formed from substantially all synthetic yarns. Furthermore, the fabrics and garments of the present invention have good resistance to pilling, despite being produced from substantially all synthetic fibers.

To achieve the above-noted advantages, the fabric of the present invention is knit from substantially all polyester yarns, preferably using a circular (weft) knitting manufacturing process. In a preferred form of the invention, the fabric is knit from air jet spun yarns. However, it is noted that other knitting processes such as warp knitting and other types of yarns (e.g. those manufactured by different methods) may also be used within the scope of the invention where they achieve the desired performance characteristics.

The fabrics desirably have a Mullen Burst strength of about 125 psi or greater, more preferably about 150 psi or greater, and even more preferably about 175 psi or greater. As will be appreciated by those of ordinary skill in the art, pilling typically is a greater problem in higher strength fabrics, since the increased strength of the yarns forming those products works against the pill balls being able to readily break off.

The fabrics also desirably have a color retention of at least about 4.0, and more preferably at least about 4.5, when tested according to AATCC Test Method 61-1996. As will be readily appreciated, this enables products made from the fabrics to retain their “like new” appearance for a greater length of time.

The fabrics also desirably have good moisture transport capabilities, which are dramatically superior to those of conventional polyester/cotton blended fabrics. More specifically, the fabrics desirably have a pre-wash moisture transport of less than 5 seconds, more preferably less than 4 seconds, even more preferably less than 3 seconds, even more preferably less than 2 seconds. In a particularly preferred embodiment of the invention, the pre-wash moisture transport of the fabrics is less than 1.5 seconds. The moisture transport characteristic is also durable, meaning that the fabric retains at least a substantial portion of its moisture transport capabilities after one or more washes.

In a preferred embodiment of the invention, the fabrics have a moisture transport after 10 industrial launderings of less than 5 seconds, more preferably less than 4 seconds, more preferably less than 3 seconds, and more preferably less than 2 seconds. In a particularly preferred form of the invention, the fabrics have a moisture transport of less than 1 second after 10 industrial launderings, which provides outstanding wicking characteristics to the product made from the fabric. Because the ability of a fabric to wick moisture strongly affects its comfort, this ability of the fabric to wick renders it particularly useful in the manufacture of garments which are comfortable for a wearer.

The fabrics also desirably have good pill resistance, preferably having at least a 4.0 rating after 10 industrial launderings when tested according to the ASTM Test Method D3512 Random Tumble pill test.

The fabrics also desirably have good soil release capabilities, preferably having a soil release rating of greater than 3.0 after 1 home wash and after 5 home washes. Even more preferably, the fabrics have a soil release rating of about 3.5 or greater after 1 home wash and after 5 home washes, and even more preferably about 4.0 or greater after 5 home launderings. (For purposes of this application, “home washes” are considered to be those designed to simulate a conventional washing procedure that a person may use at home, which will typically be performed at 120° F., as compared with the 165° F. temperatures used for industrial laundering processes. The home laundering processes described herein were performed according to AATCC Test Method 135-1995 at 120° F., while the industrial launderings were performed according to AATCC Test Method 135-1995 at 165° F.)

The term “durable soil release” is intended to describe that the fabric retains a substantial portion of its soil release capabilities after being subjected to one or more washes. In a preferred form of the invention, the fabrics will have soil release which is durable for at least 1 home washing, more preferably for at least 5 home washings, and even more preferably for at least 10 home washings. As will be readily appreciated by those of ordinary skill in the art, fabrics can generally be expected to have better soil release performance when washed at higher temperatures. Therefore, it is to be expected that the soil release performance would be even greater when the fabrics are industrially laundered than when they are home laundered.

In addition, the fabrics desirably have a soft hand which is at least as good as, and preferably is softer than that of similar weight polyester/cotton fabrics. Furthermore, the hand is desirably a “generic” or “unisex” type of hand, which is appropriate for the production of garments for both males and females. Preferably, the fabrics have a surface roughness SMD value (when tested using commonly available Kawabata testing equipment) of less than about 10 micrometers, and more preferably less than about 9 micrometers. In addition, the fabrics also have a stiffness (B) rating when testing using Kawabata equipment of less than about 0.05 grams·force/cm, more preferably less than about 0.04 grams·force/cm, even more preferably less than about 0.03 grams·force/cm, and even more preferably, on the order of about 0.02 grams·force/cm.

### DESCRIPTION OF THE DRAWINGS

FIG. 1 illustrates a process which can be used to produce fabrics according to the present invention.

### DETAILED DESCRIPTION

In the following detailed description of the invention, specific preferred embodiments of the invention are described-to enable a full and complete understanding of the invention. It will be recognized that it is not intended to limit the invention to the particular preferred embodiment described, and although specific terms are employed in describing the invention, such terms are used in a descriptive sense for the purpose of illustration and not for the purpose of limitation.

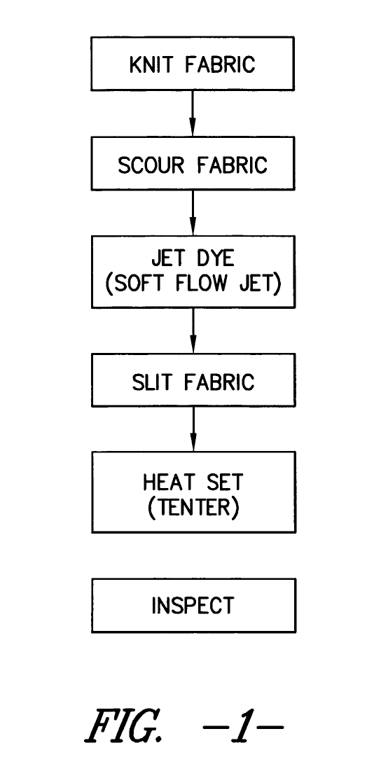

With reference to FIG. 1, a process for producing a fabric according to the invention will be described. The process involves providing a substantially all-polyester fabric, preferably which is knit, and even more preferably which is a circular (weft) knit fabric. As noted, the fabric is preferably substantially all-polyester, and is desirably made from air jet spun yarns about 16 to about 40 cotton count in size. (As will be readily appreciated by those of ordinary skill in the art, air jet spun yarns are those yarns which are produced by wrapping fibers around a core stream of fibers by way of compressed air.) The fabric is desirably scoured to remove oils, sizes, lubricants, etc. that may be present on the fabric from the fabric manufacturing operation.

The fabric is then desirably jet dyed using a soft flow dyeing process. Such processes are known for their use in connection with the processing of fragile fabrics, but heretofore to the inventors' knowledge have not been used in connection with more durable type fabrics such as substantially all-polyester fabrics. The dye bath, in addition to dyestuffs, desirably includes chemistry designed to promote moisture transport and soil release properties to the fabric, as well as a defoamer, dispersing agent, pH controlling agent, and reducing agent, to remove excess dyes.

The fabric is desirably slit and then heat set, preferably at a relatively low temperature on the order of about 340° F.-400° F., and more preferably at about 360° F.

The fabrics of the invention have a soft “generic” hand, meaning that they can be used to form garments worn by both male and female wearers. The fabrics also have good color retention and consistency, as well as extremely high strength and good wicking capabilities. In addition, the fabrics retain all of these characteristics after a number of industrial launderings. Preferably they have good color retention, soil release and moisture transport properties after being industrially laundered one or more times. Even more preferably, the fabrics retain their properties after repeated industrial launderings. Furthermore, the fabrics have superior pill resistance, which is surprising due to their substantially all-polyester composition.

In a preferred form of the invention useful in the manufacture of rental shirts, the fabrics have a finished weight of about 2 to about 15 oz/sq yd, more preferably about 4 to about 10 oz/sq yd, and even more preferably about 5 to about 6 oz/sq yd. In addition, the fabrics desirably have high strength, and in particular, Mullen burst strength of-about 100 to about 250 psi, more-preferably about 150 to about 200 psi, and even more preferably about 175 to about 185 psi.

A conventional 65/35 polyester/cotton fabric of 20 s open end spun yarns, of the variety conventionally used in the manufacture of knit shirts was obtained and tested in the manner described below, with the results being listed under Example A. A like-colored shirt made according to the present invention was tested in the same manner, with the results being listed below as Example B. More specifically, the fabric was produced as follows:

A circular knit fabric made from 100% polyester 20 s air jet spun yarns was provided. The fabric was scoured in a conventional manner to remove lubricants and the like which remained from the yarn production and knitting processes. The fabric was then jet dyed in a Thies jet dye machine using a soft flow dye process as follows:

The jet was filled to load volume. The fabric was loaded, then circulated at 95° for 10 minutes to water scour the fabric. The jet was emptied, then filled to run level.

The following chemicals were dropped into the jet at the following concentrations: 2% of a defoamer, 1.5% high molecular ethoxylated polyester, 1.5% ethoxylated sulfonated polyester, 4% of a dispersing agent (to promote uniform dispersion of the dyestuffs in the jet), 0.45% acetic acid 84% (for pH control), 0.1% of a chealating agent (e.g. Trilon BX liquid) to remove heavy metals from the solution. The dyes were added as 1.1520% Dianix Yellow liquid, 0.9486 Foron Rubine powder, and 3.05% Bucron navy 100% liquid.

The bath was heated to 170° F. at a rate of about 2° F. per minute. The bath temperature was then increased to about 280° at a rate of about 2° F. per minute. The fabric was then held for an hour at 280° F., then allowed to cool to 170° F. at a rate of about 4° F. per minute. The jet liquor was then emptied, and the jet filled with water at 120° F. This water was circulated for 5 minutes, then the jet was emptied again. The jet was then filled to run level with water at about 120° F., then the after clear chemicals were dropped (i.e. 2% soda ash and 0.5% reducing agent). The bath was then heated to about 160° F. at a rate of about 3½° F. per minute. The fabric was held for about 20 minutes at 160° F., then the jet liquor was emptied. The jet was again filled to run level with water at 110° F., circulated for 5 minutes, then the liquor emptied. The jet was again filled with water at 110° F. water, circulated for 5 minutes, and emptied. The jet was then filled to run level with water at 120° F., held for 3 minutes, then unloaded.

The fabric was then slit in a conventional manner, and heatset on a tenter frame at the low end of acceptable heat setting temperatures. In other words, while similar fabrics would normally be heatset at temperatures approaching 380°, care was taken to keep the temperatures at the tenter at about 340° F. to about 360°.

The fabric had a finished width of about 66-68 inches IP (inside pins), and a finished weight of about 5½-6 oz/sq yard.

The test methods used on the fabrics were as follows:

Color Retention: Color retention was tested according to AATCC Test Method 61-1996.

Pilling: Pilling was tested according to ASTM Test Method D3512.

Shrinkage: Shrinkage was tested according to AATCC Test Method 135. This test method raised the temperature of the fabrics to 140° F.; it is noted that many industrial laundering processes expose the fabrics to even higher temperatures, e.g. on the order of about 165° F.

Stretch: Stretch of the fabrics was tested according to ASTM Test Method D2594.

Mullen Burst Strength: Mullen Burst Strength was tested according to ASTM Test Method D231.

Soil Release: Soil release was tested according to AATCC Test Method 130-1995.

Moisture Transport: Moisture transport was tested according to a drop disappearance method (which is a modified version of AATCC Test Method 39-1980) as follows: Fabric specimens were allowed to reach equilibrium with the environment of the testing area. Each sample was large enough so that three different areas could be tested. The sample was placed in an embroidery hoop with the back up and with the fabric sufficiently taut so that there was no noticeable sag with the fabric face down. One drop of distilled water was allowed to fall onto the back of the fabric from a height of one inch. A timer was started immediately. The drop of water was watched until it was completely absorbed (i.e. no specular reflectance) into the fabric and the timer was stopped at that moment or when it reached 5.0 seconds. The time for the drop to be absorbed was then recorded. The average of three times was reported to the nearest 0.1 seconds. Average times less than 0.5 seconds were reported as 0.0 seconds. Individual times equal to or greater than 5.0 seconds were assigned a value of 5.0 seconds before averaging. If all three times were greater than 5.0 seconds, the average time was recorded as greater than 5.0 seconds. A moisture transport of greater than 5 seconds is considered to be a failure from a product performance standpoint.

Surface Test SMD (Roughness): Surface roughness was measured using a Kawabata Test Instrument according to its prescribed instructions. The sensitivity 1 was set at 2 & ×5, as was sensitivity 2. The fabric orientation was “front” “fill”, tension weight was 480 grams, and the surface roughness weight was 10 grams. The surface test measures frictional properties and geometric roughness properties of the surface of the fabric.

The sample of fabric was moved first in a forward direction and then back (under constant tension) while underneath and in contact with a frictional contactor. The frictional drag force was measured while the contactor was under constant force normal to the fabric surface. The SMD represents the mean deviation of the displacement of the contactor normal to the surface [microns]. 1 micron=10⁻³ mm=10⁻⁶ m. With Example A, two specimens were tested 4 times each, while with Example B, 1 specimen was tested 4 times. A higher SMD value indicates a rougher fabric.

Pure Bending Test: The Bending of the Example A and B fabrics was obtained using a Kawabata Test instrument in its prescribed manner, such equipment being commercially available and well-known to those of ordinary skill in the art. The sensitivity was set at 2 &×1, and the sample size was 20×20 cm.

The bending test measures the resistive force encountered when a piece of fabric that is held or anchored in a line parallel to the warp or filling is bent in an arc. The fabric is bent first in the direction of one side and then in the direction of the other side. This action produces a hysteresis curve since the resistive force is measured during bending and unbending in the direction of each side. The width of the fabric in the direction parallel of the bending axis affects the force. The test ultimately measures the bending momentum and bending curvature. The B value represents the mean bending stiffness per unit width [gf-cm²/cm]. A lower bending value (B) is indicative of a softer fabric hand.

Hand: Hand was evaluated in a conventional manner by a hand jury, which means that the fabrics were felt and classified as to their feel as being either harsh or soft.

TABLE 1

| CHARACTERISTICS | SAMPLE A | SAMPLE B |
|---|---|---|
| Construction (Finished) | | |
| Fiber Type | Polyester/Cotton | 100% 1.0 dpf |
| | 65/35 | low tenacity |
| | | textured |
| | | Polyester (flat |
| | | cross-section |
| Type of Yarn | 20s, Open end | 20s, Air jet |
| | spun | spun |
| Weight (oz/Iinear yd.) | 10.70 | 10.90 |
| Weight (oz/sg. yd.) | 5.60 | 5.73 |
| Width cuttable | 66″IP | 66″IP |
| Construction | jersey | jersey |
| Performance Characteristics | | |
| Mullen Burst | 102 PSI | 184 PSI |
| Random Tumble Pilling 60 | 3.5/4.0 | 4.0 |
| Mins. (after 10 Industrial | | |
| Washes at 165° F.) | | |
| Soil Release: after I Home | 3.0/3.0 | 3.5/4.0 |
| Wash at 120° F./after 5 Home | | |
| Washes at 120° F. | | |
| Color Retention | 3.5 | 4.5 |
| Moisture Transport: Pre-Wash | >5 seconds | 1.3 Sec. |
| Moisture Transport: after 10 | >5 seconds | 0.7 Sec. |
| Industrial Washes at 165° F. | | |
| Wash Shrinkage: after 10 | 7% × 3% | 5.9% × 0.6% |
| Industrial Launderings at | | |
| 165° F. (wale direction X course | | |
| direction) | | |
| Hand | | |
| Surface Test-SMD | 10.650 | 8.046 |
| (micrometers) | | |
| Pure Bending Test-Stiffness | | |
| (B) | 0.055 | 0.020 |
| (grams · force/cm) | | |
| Hand | Harsh | Soft |

As noted, the fabric of the present invention had dramatically superior Mullen Burst strength, color retention and moisture transport than the conventional polyester/cotton fabric. In addition, the fabric of the invention had superior pill resistance to the polyester/cotton fabric. Furthermore, the fabric of the invention surprisingly had a softer hand than the polyester/cotton fabric, which was readily apparent when comparing the two fabrics, and as evidenced by the lower roughness (SMD value) and stiffness (B value.)

The fabrics made according to the invention have particular utility in the manufacture of industrially launderable garments, rendering them-particularly useful in the rental garment market. For one, the fabrics have dramatically superior color retention after industrial laundering to the traditional polyester/cotton fabrics, which enables garments made from the fabrics to retain their original appearance for a much greater length of time, despite being laundered under industrial conditions. The fabrics of the invention were also found to have color retention ratings of 4.0 after 50 industrial launderings, and after 50 home washes. As will be readily appreciated by those of ordinary skill in the art, such color retention plays an important part in the lifespan of the garment, particularly where the garment is to be used in the rental garment market (e.g. the occupational apparel market.)

Secondly, the moisture transport of these fabrics is much greater than that of the polyester/cotton fabric, meaning that it would be expected to wick perspiration and moisture away from the wearer quickly, thereby providing greater comfort to the wearer. This is surprising since fabrics containing natural fibers are generally considered to have greater moisture transport capabilities and be more comfortable to a wearer than garments made from all synthetic fibers. In addition, to the moisture transport properties being durable, it was shown that the moisture transport improved after the fabric was laundered a number of times. Similarly, the fabric of the invention displayed superior durable soil release capabilities, which improved as the fabric was laundered.

In addition to the above tests, additional characteristics of the fabric of the invention were tested and compared with product specifications identified by a garment manufacturer for polyester/cotton fabrics for use in top weight garments. These polyester/cotton specifications were met or exceeded in all of these categories by the fabric of the invention, and in fact were exceeded for colorfastness and crocking, as well as walewise and coursewise stretch. The test methods used are as follows:

Colorfastness: Colorfastness was tested according to AATCC Test Method 61-IIA.

Flat Dry Appearance: Flat dry appearance was determined using AATCC Test Method 124-1996.

Snag Resistance: Snag resistance was tested according to ASTM Test Method D3939.

Crocking: Wet and dry crocking were tested according to AATCC Test Method 8-1996.

TABLE 2
Conventional Polyester/Cotton Fabric Specifications vs. Test
Results for Example B

| | Product | |
|---|---|---|
| Characteristic | Specification | Example B |
| Colorfastness-IIA Wash Test | 3.5 | 4.0 |
| to Polyester | | |
| Length Stretch | 25% minimum | 28% |
| Width Stretch | 25% minimum | 56% |
| Stretch Recovery | 95% minimum | 95% |
| Flat Dry Appearance | 3.5 | 3.5 |
| Snag Resistance | 4.0 | 4.0 |
| Crocking, Wet X Dry | 3.5 × 4.0 | 4.5 × 5.0 |

The fabrics described herein have particular utility in the manufacture of garments which are designed to withstand industrial laundering processes, such as those used in the rental garment market. Such garments include, but are not limited to shirts, jackets, pants, hats, scarves, dresses, uniforms, and the like. The manufacture of such items is well known in the art, and therefore the specific garment manufacturing processes have not been described herein. However, it is to be noted that the fabrics may be used for markets other than apparel, where a durable industrially launderable fabric would have utility.

In the following detailed description of the invention, specific preferred embodiments of the invention are described to enable a full and complete understanding of the invention. It will be recognized that it is not intended to limit the invention to the particular preferred embodiment described, and although specific terms are employed in describing the invention, such terms are used in a descriptive sense for the purpose of illustration and not for the purpose of limitation.

We claim:

1. A knit fabric particularly suitable for use in the production of industrially-launderable garments, said fabric being formed from air jet spun, substantially all polyester yarns and having durable moisture transport properties and a color retention of greater than 3.5 when tested according to AATCC Test Method 61-1996.

2. The fabric according to claim 1, wherein said fabric has a Mullen Burst strength of about 125 psi or greater.

3. The fabric according to claim 1, wherein said fabric has a Mullen Burst strength of about 150 psi or greater.

4. The fabric according to claim 1.2, wherein said fabric has a Mullen Burst strength of about 175 psi or greater.

5. The fabric according to claim 1, wherein said fabric scores about a 4.0 or greater on a Random Tumble pilling test after 10 industrial washes.

6. The fabric according to claim 1, wherein said fabric has a soil release rating of greater than 3.0 after one home wash.

7. The fabric according to claim 1, wherein said fabric has a soil release rating of about 3.5 or greater after one home wash.

8. The fabric according to claim 1, wherein said fabric has a soil release rating of greater than 3.0 after 5 home washes.

9. The fabric according to claim 8, wherein said fabric has a soil release rating of about 4.0 or greater after 5 home washes.

10. The fabric according to claim 1, wherein said fabric has a moisture transport of less than 5 seconds before it is washed.

11. The fabric according to claim 1, wherein aid fabric has a moisture transport of less than 3 seconds before it is washed.

12. The fabric according to claim 1, wherein said fabric has a moisture transport of less than 1.5 seconds before it is washed.

13. The fabric according to claim 1, wherein said fabric has a moisture transport of less than 5 seconds after 10 industrial washes.

14. The fabric according to claim 1, wherein said fabric has a moisture transport of less than 3 seconds after 10 industrial washes.

15. The fabric according to claim 1, wherein said fabric has a moisture transport of less than 1 second after 10 industrial washes.

16. The fabric according to claim 1, wherein said fabric has an SMD surface roughness value of about 10 micrometers or less.

17. The fabric according to claim 1, wherein said fabric has an SMD surface roughness value of about 9 micrometers or less.

18. The fabric according to claim 1, wherein said fabric has a bending stiffness ofless than about 0.05 grams·force/cm.

19. The fabric according to claim 1, wherein said fabric has a finished weight of about 6 oz/sq yard.

20. The fabric according to claim 1, wherein said fabric has a colorfastness to polyester of 3.5 or greater when subjected to a AATCC Test Method 61-1996.

21. The fabric according to claim 1.14, wherein said fabric has a colorfastness to polyester of 4.0 or greater.

22. The fabric according to claim 1, wherein said fabric has a color retention of about 4.0 or greater when tested according to AATCC Test Method 61-1996.

23. The fabric according to claim 1, wherein said fabric has a color retention of about 4.5 or greater when tested according to AATCC Test Method 61-1996.

24. The fabric according to claim 1, wherein said fabric has a color retention of about 4.0 or greater after 50 home washes.

25. The fabric according to claim 1, wherein said fabric has a color retention of about 4.0 or greater after 50 industrial washes.

26. A garment made from the fabric of claim 1.

27. A knit fabric particularly suitable for use in the production of industrially-launderable garments, said fabric being formed from about 16 s to about 40 s substantially all polyester yarns, said fabric having a Mullen Burst strength of at least about 125 psi and a pill rating of about 4.0 or greater when subjected to a Random Tumble pilling test after 10 industrial washes.

28. The fabric according to claim 27, wherein said fabric has a color retention rating of about 3.5 or greater when tested according to AATCC Test Method 61-1996.

29. The fabric according to claim 27, wherein said fabric has a color retention rating of at least about 4.0 when tested according to AATCC Test Method 61-1996.

30. The fabric according to claim 27, wherein said fabric has a color retention rating of at least about 4.5 when tested according to AATCC Test Method 61-1996.

31. The fabric according to claim 27, wherein said fabric comprises air jet spun yarns.

32. The fabric according to claim 27, wherein said fabric has a Mullen Burst strength of about 150 psi or greater.

33. The fabric according to claim 27, wherein said fabric has a Mullen Burst strength of about 175 psi or greater.

34. The fabric according to claim 27, wherein said fabric has durable soil release characteristics.

35. The fabric according to claim 27, wherein said fabric has a soil release rating of about 3.5 or greater after one home wash.

36. The fabric according to claim 27, wherein said fabric has a soil release rating of about 3.5 or greater after 5 home washes.

37. The fabric according to claim 27, wherein said fabric has a soil release rating of about 4.0 or greater after 5 home washes.

38. The fabric according to claim 27, wherein said fabric has a moisture transport rating of about less than about 5 seconds before it is washed.

39. The fabric according to claim 27, wherein said fabric has a moisture transport rating of about less than about 2 seconds.

40. The fabric according to claim 27, wherein said fabric has a moisture transport rating of less than about 5 seconds after 10 industrial washes.

41. The fabric according to claim 27, wherein said fabric has a moisture transport rating of less than about 1 second after 10 industrial washes.

42. The fabric according to claim 27, wherein said fabric has an SMD roughness value of about 10 micrometers or less.

43. The fabric according to claim 27, wherein said fabric has an SMD roughness value of about 9 micrometers or less.

44. The fabric according to claim 27, wherein said fabric has a bending stiffness of less than about 0.05 grams·force/cm.

45. A garment made from the fabric of claim 27.

46. A knit fabric particularly suitable for use in the production of industrially-launderable garments, said fabric being substantially all-polyester, having durable moisture transport properties and having a color retention rating of at least about 4.0 when tested according to AATCC Test Method 61-1996.

47. A knit fabric according to claim 46, wherein said fabric has a soil release rating of about 3.5 or greater after 1 industrial laundering.

48. A knit fabric according to claim 46, wherein said fabric has a soil release rating of about 3.5 or greater after 5 industrial launderings.

49. A knit fabric according to claim 46, wherein said fabric has a soil release rating of about 4.0 or greater after 5 industrial launderings.

50. A knit fabric according to claim 46, wherein said fabric has a moisture transport of less than about 5 seconds before it is washed.

51. A knit fabric according to claim 46, wherein said fabric has a moisture transport of less than about 2 seconds before it is washed.

52. A knit fabric according to claim 46, wherein said fabric has a moisture transport of less than about 5 seconds after 10 industrial washes.

53. A knit fabric according to claim 46, wherein said fabric has a moisture transport of less than about 1 second after 10 industrial washes.

54. A knit fabric according to claim 46, wherein said fabric has an SMD surface roughness value of about 10 micrometers or less.

55. A knit fabric according to claim 46, wherein said fabric has an SMD surface roughness value of about 9 micrometers or less.

56. A knit fabric according to claim 46, wherein said fabric has a bending stiffness of less than about 0.05 grams·force/cm.

57. A knit fabric particularly suitable for use in the production of industrially-launderable garments, said fabric being made from air jet spun, substantially all-polyester yarns, said fabric having an SMD surface roughness value of about 10 micrometers or less.

58. A fabric according to claim 57, wherein said fabric has an SMD surface roughness value of about 9 micrometers or less.

59. A fabric according to claim 57, wherein said fabric has a bending stiffness of less than about 0.05 grams·force/cm.

60. A fabric according to claim 57, wherein said fabric has a bending stiffness of less than about 0.03 grams·force/cm.

61. A fabric according to claim 57, wherein said fabric has a finished weight of about 4 to about 10 oz/sq.yd.

62. A fabric according to claim 57, wherein said fabric comprises yarns about 20 s in size.

63. A fabric according to claim 57, wherein said fabric has a Mullen Burst strength of about 125 psi or greater.

64. A fabric according to claim 57, wherein said fabric scores about a 4.0 or greater on a Random Tumble pilling test after 10 industrial washes.

65. A fabric according to claim 57, wherein said fabric has a soil release of about 3.5 or greater after one home wash.

66. A fabric according to claim 57, wherein said fabric has a soil release value of about 3.5 or greater after 5 home washes.

67. A fabric according to claim 57, wherein said fabric has a soil release value of about 4.0 or greater after 5 home washes.

68. A fabric according to claim 57, wherein said fabric has a moisture transport of less than about 5 seconds before it is washed.

69. A fabric according to claim 57, wherein said fabric has a moisture transport of less than about 5 seconds after 10 industrial washes.

70. A knit fabric particularly suitable for use in the production of industrially-launderable garments, said fabric being made from air jet spun, substantially all-polyester yarns, said fabric having a bending stiffness of less than about 0.05 grams·force/cm.

71. A fabric according to claim 70, wherein said fabric has an SMD surface roughness value of about 10 micrometers or less.

72. A fabric according to claim 70, wherein said fabric has an SMD surface roughness value of about 9 micrometers or less.

73. A fabric according to claim 70, wherein said fabric has a finished weight of about 4 to about 10 oz/sq.yd.

74. A fabric according to claim 70, wherein said fabric comprises yarns about 20 s in size.

75. A fabric according to claim 70, wherein said fabric has a Mullen Burst strength of about 125 psi or greater.

76. A fabric according to claim 70, wherein said fabric scores about a 4.0 or greater on a Random Tumble pilling test after 10 industrial washes.

77. A fabric according to claim 70, wherein said fabric has a soil release of about 3.5 or greater after one home wash.

78. A fabric according to claim 70, wherein said fabric has a soil release value of about 3.5 or greater after 5 home washes.

79. A fabric according to claim 70, wherein said fabric has a soil release value of about 4.0 or greater after 5 home washes.

80. A fabric according to claim 70, wherein said fabric has a moisture transport rating of less than about 5 seconds before it is washed.

81. A fabric according to claim 70, wherein said fabric has a moisture transport of less than about 5 seconds after 10 industrial washes.
